(19) United States
(12) Patent Application Publication
(10) Pub. No.: US 2020/0047738 A1
(43) Pub. Date: Feb. 13, 2020

(54) SYSTEM AND METHOD FOR PROVIDING BRAKE-ASSISTED STEERING TO A WORK VEHICLE BASED ON WORK VEHICLE WHEEL SPEEDS

(71) Applicant: CNH Industrial America LLC, New Holland, PA (US)

(72) Inventor: Joshua D. Zimmerman, Willow Springs, IL (US)

(73) Assignee: CNH Industrial America LLC

(21) Appl. No.: 16/102,021

(22) Filed: Aug. 13, 2018

(51) Int. Cl. B60W 10/188; B60W 10/20; B60T 11/21

(52) U.S. Cl. CPC B60W 10/188; B60W 10/20; B60T 11/21; B60Y 2400/81; B60W 2300/152; B60W 2422/70; B60Y 2400/3032; B60W 2520/28

(57) ABSTRACT

In one aspect, a system for providing brake-assisted steering to a work vehicle may include at least one sensor configured to detect at least one parameter associated with a wheel speed differential defined between first and second wheels of the work vehicle. The system may also include a controller configured to determine a target wheel speed differential between the first and second wheels when it is determined that a change in the direction of travel of the work vehicle has been initiated. Furthermore, the controller may be configured to control the operation of a first or second braking device of the work vehicle such that a braking force is applied to an inside wheel of the work vehicle in a manner that adjusts the wheel speed differential towards the target wheel speed differential.

### FIELD OF THE INVENTION

The present disclosure generally relates to work vehicles and, more particularly, to systems and methods for providing brake-assisting steering to a work vehicle based on work vehicle wheel speeds.

### BACKGROUND OF THE INVENTION

Work vehicles, such as tractors and other agricultural vehicles, typically include a pair of steerable wheels and a steering actuator for turning or otherwise adjusting the direction of travel of the work vehicle. More specifically, when a turn is initiated, the steering actuator adjusts the positions of the steerable wheels relative to a frame of the vehicle such that a steering angle is defined between the direction of the wheels and the direction of the frame. Thereafter, the direction of travel of the work vehicle is adjusted by the steering angle such that the vehicle is moved in the direction of travel of the steerable wheels.

In general, increasing the steering angle of the work vehicle decreases its turning radius. However, the work vehicle has a minimum turning radius that is limited by its geometry. Moreover, field conditions, such as wet or muddy conditions, may further limit the minimum turning radius of the work vehicle. As such, the minimum turning radius of the work vehicle may be insufficient to complete certain turns, such as turns at the ends of crop rows. In such instances, the operator of the work vehicle may be forced to perform time-consuming three-point or bulb-shaped turns.

Accordingly, an improved system and method for providing brake-assisting steering to a work vehicle to decrease its minimum turning radius would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to a system for providing brake-assisted steering to a work vehicle. The system may include first and second wheels, with one of the first or second wheels corresponding to an inside wheel of the work vehicle and another of the first or second wheels corresponding to an outside wheel of the work vehicle when a direction of travel of the work vehicle is being changed. The system may also include first and second braking devices, with the first braking device configured to apply a braking force to the first wheel and the second braking device configured to apply a braking force to the second wheel. Furthermore, the system may include at least one sensor configured to detect at least one parameter associated with a wheel speed differential defined between the first and second wheels. Additionally, the system may include a controller communicatively coupled to the at least one sensor. The controller may be configured to determine a target wheel speed differential between the first and second wheels when it is determined that a change in the direction of travel of the work vehicle has been initiated. Moreover, the controller may further be configured to control an operation of the first braking device or the second braking device such that a braking force is applied to the inside wheel in a manner that adjusts the wheel speed differential towards the target wheel speed differential.

In another aspect, the present subject matter is directed to a system for providing brake-assisted steering to a work vehicle. The system may include first and second wheels, with one of the first or second wheels corresponding to an inside wheel of the work vehicle when a direction of travel of the work vehicle is being changed. The system may also include first and second braking devices, with the first braking device configured to apply a braking force to the first wheel and the second braking device configured to apply a braking force to the second wheel. The system may further include a steering angle sensor configured to detect a parameter indicative of a steering angle of the work vehicle. Moreover, the system may include a wheel speed sensor configured to detect a parameter associated with a wheel speed of the inside wheel. Additionally, the system may include a controller communicatively coupled to the steering angle sensor and the wheel speed sensor. The controller may be configured to determine an expected wheel speed of the inside wheel based on measurement signals received from the steering angle sensor and the wheel speed sensor when it is determined that a change in the direction of the work vehicle has been initiated. The controller may also be configured to determine a target wheel speed based on the expected wheel speed, with the target wheel speed being less than the expected wheel speed. Furthermore, the controller may be configured to control an operation of the first or second braking device in a manner that reduces a wheel speed of the inside wheel to the target wheel speed.

In a further aspect, the present subject matter is directed to a method for providing brake-assisted steering to a work vehicle. The method may include controlling, with a computing device, an operation of a work vehicle such that the work vehicle is moved along a direction of travel. The work vehicle may include first and second wheels, with one of the first or second wheels corresponding to an inside wheel of the work vehicle when the direction of travel of the work vehicle is being changed. The work vehicle may further include a first braking device configured to apply a braking force to the first wheel and a second braking device configured to apply a braking force to the second wheel. The method may also include determining, with the computing device, a target wheel speed differential between the first and second wheels when a change in the direction of travel of the work vehicle has been initiated. Furthermore, the method may include controlling, with the computing device, an operation of the first braking device or the second braking device such that a braking force is applied to the inside wheel in a manner that adjusts a wheel speed differential defined between the first and second wheels towards the target wheel speed differential.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a top view of one embodiment of a work vehicle in accordance with aspects of the present subject matter;

FIG. 2 illustrates a side view of the work vehicle shown in FIG. 1, particularly illustrating various components of the work vehicle in accordance with aspects of the present subject matter;

FIG. 3 illustrates a schematic view of one embodiment of a braking system for a work vehicle in accordance with aspects of the present subject matter;

FIG. 4 illustrates a schematic view of one embodiment of a system for providing brake-assisted steering to a work vehicle in accordance with aspects of the present subject matter; and

FIG. 5 illustrates a flow diagram of one embodiment of a method for providing brake-assisted steering to a work vehicle in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for providing brake-assisted steering to a work vehicle. Specifically, in several embodiments, a controller of the disclosed system may be configured to determine when the work vehicle is being turned or its direction of travel is otherwise being changed. Once it is determined that the work vehicle is being turned, the controller may be configured to determine a target wheel speed differential between an inside wheel of the work vehicle and an outside wheel of the work vehicle. For example, in one embodiment, the target wheel speed differential may be based on a detected steering angle of the work vehicle. In this regard, the target wheel speed differential may generally correspond to the wheel speed differential necessary to achieve the turning radius that is associated with the detected steering angle. Thereafter, the controller may be configured to control the operation of a braking device of the work vehicle such that a braking force is applied to the inside wheel in a manner that adjusts the wheel speed differential towards the target wheel speed differential.

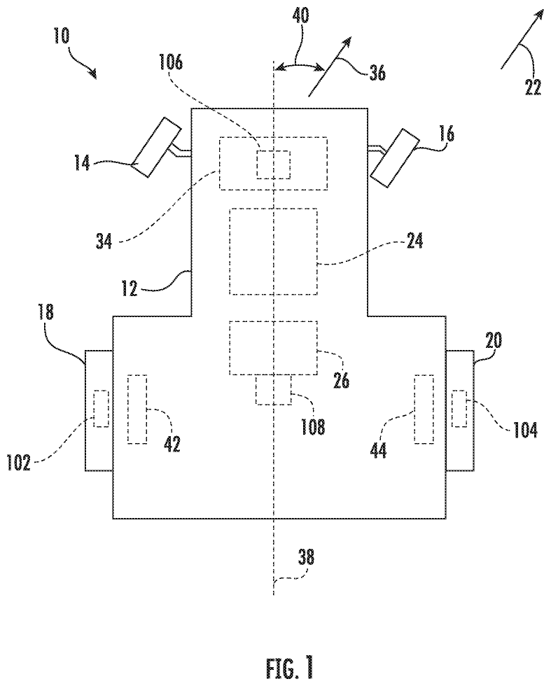

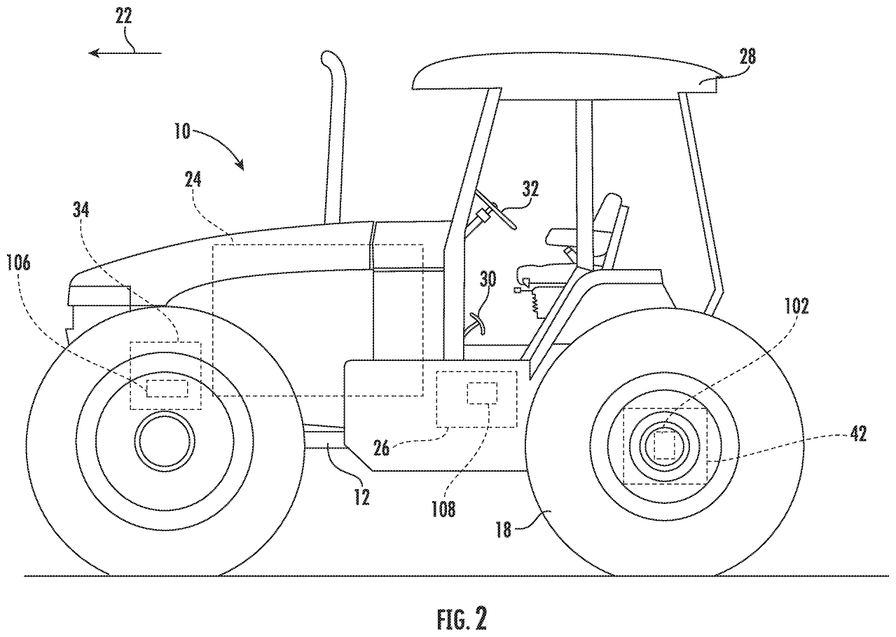

Referring now to the drawings, FIGS. 1 and 2 illustrate differing views of one embodiment of a work vehicle 10 in accordance with aspects of the present subject matter. Specifically, FIG. 1 illustrates a top view of the work vehicle 10. Additionally, FIG. 2 illustrates a side view of the work vehicle 10, particularly illustrating various components of the vehicle 10. As shown, the work vehicle 10 is configured as an agricultural tractor. However, in other embodiments, the work vehicle 10 may be configured as any other suitable work vehicle known in the art, including those for agricultural and construction applications, transport, sport, and/or the like.

As shown, the work vehicle 10 may include a frame or chassis 12 configured to support or couple to a plurality of components. For example, a pair of steerable front wheels 14, 16 and a pair of driven rear wheels 18, 20 may be coupled to the frame 12. The wheels 14, 16, 18, 20 may be configured to support the work vehicle 10 relative to the ground and move the vehicle 10 in a direction of travel (e.g., as indicated by arrow 22 in FIG. 1) across the field. In this regard, the work vehicle 10 may include an engine 24 and a transmission 26 mounted on the frame 12. The transmission 26 may be operably coupled to the engine 24 and may provide variably adjusted gear ratios for transferring engine power to the driven wheels 18, 20. Additionally, an operator's cab 28 (FIG. 2) may be supported by a portion of the frame 12 and may house various input devices, such as a brake pedal 30 (FIG. 2) and a steering wheel 32 (FIG. 2), for permitting an operator to control the operation of one or more components of the work vehicle 10. However, it should be appreciated that, in alternative embodiments, the work vehicle 10 may have any other suitable configuration and/or include any other suitable component(s). For example, in one alternative embodiment, the front wheels 14, 16 may be driven in addition to the rear wheels 18, 20.

In several embodiments, the work vehicle 10 may include a steering actuator 34 configured to adjust the direction of travel 22 of the work vehicle 10. More specifically, the direction of travel 22 of the work vehicle 10 may generally correspond to the direction of the steerable wheels 14, 16 (e.g., as indicated by arrow 36 in FIG. 1). In this regard, when the work vehicle 10 is turned or its direction of travel 22 is otherwise changed, the steering actuator 34 may be configured adjust the orientation of the steerable wheels 14, 16 relative to the frame 12. Specifically, in several embodiments, the steering actuator 34 may be configured to pivot or otherwise rotate the steerable wheels 14, 16 relative to the frame 12 based on a received input (e.g., from the steering wheel 32 (FIG. 2) or control signals from a GNSS-based guidance system (not shown)) in a manner that aligns the direction 36 of the wheels 14, 16 with the intended direction of travel of the vehicle 10. For example, as shown in FIG. 1, the steerable wheels 14, 16 have been pivoted to the right relative to a longitudinal axis (e.g., as indicated by dashed line 38 in FIG. 1) of the frame 12. In such instance, the direction of travel 22 of the work vehicle 10 may similarly be oriented to the right, thereby causing the vehicle 10 to turn right. Furthermore, when the work vehicle 10 is being turned, a steering angle (e.g., as indicated by arrow 40 in FIG. 1) may be defined between the direction 36 of the wheels 14, 16 and the longitudinal axis 38 of the frame 12. Increasing the steering angle 40 may generally decrease the turning radius of the work vehicle 10 (i.e., the turn is “sharper”). Conversely, decreasing the steering angle 40 may generally increase the turning radius of the work vehicle 10 (i.e., the turn is “wider”). It should be appreciated that the steering actuator 34 may correspond to an electric motor, a linear actuator, a hydraulic cylinder, a pneumatic cylinder, or any other suitable actuator coupled to a suitable mechanical linkage or assembly, such as a rack and pinion or a worm gear assembly.

Moreover, it should be appreciated that, when the work vehicle 10 is turned, two of the wheels 14, 16, 18, 20 may correspond to inside wheels (i.e., relative to the direction of the turn) and the other two of the wheels 14, 16, 18, 20 may correspond to the outside wheels (i.e., relative to the direction of the turn). For example, as indicated above, the work vehicle 10 shown in FIG. 1 is being turned to the right. As such, the wheels 16, 20 (i.e., the wheels on the right side of the vehicle 10) correspond to the inside wheels and the wheels 14, 18 (i.e., the wheels on the left side of the vehicle 10) correspond to the outside wheels. However, when the work vehicle 10 is turned to the left, the wheels 14, 18 on the left side of the vehicle 10 correspond to the inside wheels and the wheels 16, 20 on the right side of the vehicle 10 correspond to the outside wheels.

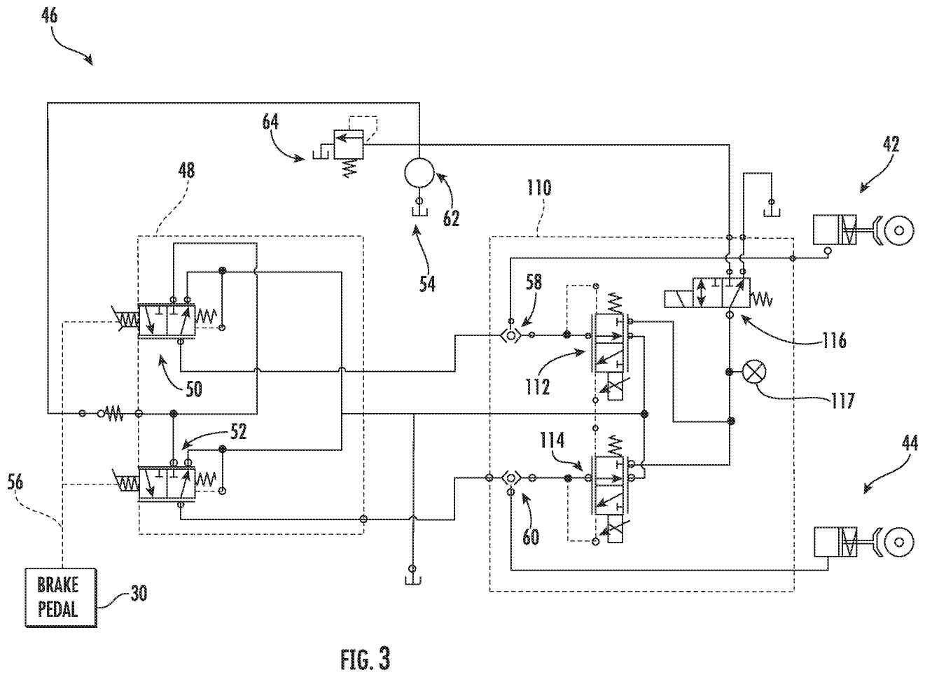

Furthermore, in several embodiments, the work vehicle 10 may include first and second braking devices 42, 44 provided in association with the driven wheels 18, 20, respectively. In this regard, the first braking device 42, when activated, may be configured to reduce the wheel speed of or otherwise slow the rotation of the associated wheel 18. Similarly, the second braking device 44, when activated, may be configured to reduce the wheel speed of or otherwise slow the rotation of the associated wheel 20. Moreover, in one embodiment, the first and second braking devices 42, 44 may be configured for independent activation. That is, each of the first and second braking device 42, 44 may be activated without also activating the other of the first and second braking devices 42, 44. As will be described below, the work vehicle 10 may include a braking system 46 (FIG. 3) configured to control the operation of the first and second braking devices 42, 44. It should be appreciated that, in alternative embodiments, additional braking devices may be provided in association with the steerable wheels 14, 16.

Additionally, it should be appreciated that the braking devices 42, 44 may correspond to any suitable device(s) for reducing the wheel speeds of the wheels 18, 20, such as by converting energy associated with the movement of such wheels 18, 20 into heat. For example, in one embodiment, the braking devices 42, 44 may correspond to suitable hydraulic cylinders configured to push stationary frictional elements (not shown), such as brake shoes or brake calipers, against rotating elements (not shown), such as brake drums or brake discs. However, it should be appreciated that the braking devices 42, 44 may correspond to any other suitable hydraulic, pneumatic, mechanical, and/or electrical components configured to convert the rotation of the rotating elements into heat.

In accordance with aspects of the present subject matter, first and second wheel speed sensors 102, 104 may be provided in operative association with the work vehicle 10. Specifically, in several embodiments, a first wheel speed sensor 102 may be provided in operative association with the driven wheel 18 and a second wheel speed sensor 104 may be provided in operative association with the driven wheel 20. In this regard, the first wheel speed sensor 102 may be configured to detect a parameter associated with the wheel speed of the driven wheel 18. Similarly, the second wheel speed sensor 104 may be configured to detect a parameter associated with the wheel speed of the driven wheels 20. For example, in one embodiment, the first and second wheel speed sensors 102, 104 may be configured as Hall Effect sensors configured to detect the rotational speeds of the driven wheels 18, 20, respectively. However, it should be appreciated that, in alternative embodiments, the first and second wheel speed sensors 102, 104 may correspond to any other suitable types of sensors. Furthermore, it should be appreciated that, in further embodiments, the work vehicle 10 may include additional wheel speed sensors provided in operative association with the steerable wheels 14, 16.

Moreover, a steering angle sensor 106 may be provided in operative association with the work vehicle 10. Specifically, in several embodiments, the steering angle sensor 106 may be configured to detect a parameter associated with the steering angle 40 defined between the steerable wheels 14, 16 and the frame 12. As such, in one embodiment, the steering angle sensor 106 may be provided in operative association with the steering actuator 34. For example, in such embodiment, the steering angle sensor 106 may be configured as a potentiometer configured to detect relative movement between the steerable wheels 14, 16 and the frame 12. However, it should be appreciated that, in alternative embodiments, the steering angle sensor 106 may be configured as any other suitable type of sensor. For example, in one embodiment, the steering angle sensor 106 may be configured as a location sensor, such as a GNSS-based receiver, configured to detect successive locations of the work vehicle 10 within the field, with such locations being indicative of the steering angle of the work vehicle 10. Additionally, in another embodiment, the steering angle sensor 106 may be configured as an inertial measurement unit configured to detect the lateral acceleration (e.g., the acceleration perpendicular to the direction of travel 22 of the work vehicle 10), with such lateral acceleration being indicative of the steering angle of the work vehicle 10.

Furthermore, a transmission speed sensor 108 may be provided in operative association with the work vehicle 10. Specifically, in several embodiments, the transmission speed sensor 108 may be configured to detect a parameter associated with the speed of an output shaft (not shown) of the transmission 26. As such, in one embodiment, the transmission speed sensor 108 may be provided in operative association with the output shaft of the transmission 26. In this regard, in such embodiment, the transmission speed sensor 108 may be configured as a Hall Effect sensor configured to detect the rotational speed of the output shaft of the transmission 26. However, it should be appreciated that, in alternative embodiments, the transmission speed sensor 108 may be configured as any other suitable type of sensor.

Referring now to FIG. 3, a schematic view of one embodiment of the braking system 46 of is illustrated in accordance with aspects of the present subject matter. In the illustrated embodiment, the braking system 46 is configured to selectively activate the first and second braking devices 42, 44 by controlling the flow of a pressurized fluid, such as hydraulic oil, to the braking devices 42, 44. However, it should be appreciated that, in alternative embodiments, the braking system 46 may be configured to selectively activate the first and second braking devices 42, 44 in any other suitable manner.

As shown in FIG. 3, the braking system 46 may include a primary brake valve assembly 48 configured to control the operation of the first and second brake devices 42, 44. In general, the primary brake valve assembly 48 may be configured to selectively activate the first and second braking devices 42, 44 in a manner that reduces the ground speed of the work vehicle 10, such as when it is desired to halt the forward movement of the vehicle 10. Specifically, in several embodiments, the primary brake valve assembly 48 may include first and second primary brake valves 50, 52 configured to control the flow of pressurized fluid from a reservoir 54 of the braking system 46 to the first and second braking devices 42, 44, respectively. For example, in one embodiment, the first and second primary brake valves 50, 52 may be configured as mechanically-actuated solenoid valves. In such embodiment, the first and second primary brake valves 50, 52 may be mechanically coupled to the brake pedal 30 of the work vehicle 10 (e.g., as indicated by dashed lines 56 in FIG. 3) to permit a braking input to be transmitted from the brake pedal 30 to primary brake valves 50, 52. Upon receipt of a braking input, the first and second primary brake valves 50, 52 may be configured to permit the flow of the pressurized fluid to the first and second braking devices 42, 44 such that the braking devices 42, 44 are activated in a manner that slows or reduces the forward speed of the work vehicle 10. In one embodiment, the first and second primary brake valves 50, 52 may be controlled as a collective unit based on the received braking input. That is, upon receipt of the braking input, the first and second primary brake valves may be configured to permit equal volumes of the pressurized fluid to flow to the first and second braking devices 40, 42 such that the braking devices 40, 42 apply equal braking forces to their associated wheels 18, 20. However, it should be appreciated that, in alternative embodiments, the first and second primary brake valves 50, 52 may be independently controllable. Furthermore, it should be appreciated that, in further embodiments, the first and second primary brake valves 50, 52 may be configured as any other suitable type of valves, such as electrically-actuated solenoid valves. In such embodiments, the first and second primary brake valves 50, 52 may be configured to receive the braking input from a suitable controller, which, in turn, receives braking inputs from the brake pedal 30 and/or a GNSS-based guidance system (not shown).

Furthermore, in several embodiments, the braking system 46 may include a brake-assisted steering (“BAS”) valve assembly 110 configured to control the operation of the first and second braking devices 42, 44 independently of the primary brake valve assembly 48. As will be described below, the BAS valve assembly 110 may be configured to selectively activate the first and second braking devices 42, 44 when the work vehicle 10 is turned in a manner that provides brake-assisted steering to the work vehicle 10. Specifically, in several embodiments, the BAS valve assembly 110 may include first and second BAS brake valves 112, 114 configured to control the flow of pressurized fluid to the first and second braking devices 42, 44, respectively. In this regard, upon receipt of a braking input, the first BAS brake valve 112 may be configured to permit the flow of the pressurized fluid to the first braking device 42, thereby activating the braking device 42 in a manner that reduces the wheel speed of the associated wheel 18. Similarly, upon receipt of a braking input, the second BAS brake valve 114 may be configured to permit the flow of pressurized fluid to the second braking device 44, thereby activating the braking device 44 in a manner that reduces the wheel speed of the associated wheel 20. As such, the first and second BAS brake valves 112, 114 may be configured for independent actuation. That is, each of the first and second BAS brake valves 112, 114 may be actuated without also actuating the other of the BAS brake valves 112, 114. In one embodiment, the first and second BAS brake valves 112, 114 may be configured as electrically-actuated solenoid valves. However, it should be appreciated that, in alternative embodiments, the first and second BAS brake valves 112, 114 may be configured as any other suitable type of valves.

In one embodiment, the BAS valve assembly 110 may also include a shut-off valve 116 configured to selectively occlude the flow of the pressurized fluid from the reservoir 54 to the first and second BAS brake valves 112, 114. Specifically, when the shut-off valve 116 is at an opened position, the pressurized fluid may be permitted to flow from the reservoir 54 to the first and second BAS brake valves 112, 114 such that the BAS brake valves 112, 114 may control the delivery of such fluid to the braking devices 42, 44. Conversely, when the shut-off valve 116 is at a closed position, the pressurized fluid may be prevented from flowing from the reservoir 54 to the first and second BAS brake valves 112, 114. In such instances, the flow of pressurized fluid through the first and second BAS brake valves 112, 114 to the associated first and second braking device 42, 44 may be prevented even when the BAS valves 112, 114 are opened. As such, the shut-off valve 116 may generally be located upstream of the first and second BAS brake valves 112, 114. In one embodiment, the shut-off valve 116 may be configured as an electrically-actuated solenoid valve. However, it should be appreciated that, in alternative embodiments, the shut-off valve 116 may be configured as any other suitable type of valve.

Additionally, in several embodiments, the braking system 46 may include first and second shuttle valves 58, 60. More specifically, in certain instances, the primary and BAS brake valve assemblies 48, 110 may simultaneously provide the pressurized fluid to the first and second braking devices 42, 44, such as when the brake pedal 30 is depressed while the work vehicle 10 is being turned. In such instances, the braking force applied to the wheels 18, 20 by the first and second braking devices 42, 44, respectively, may be greater than intended. That is, the braking force applied in such instances may be the sum of the braking force associated with slowing the ground speed of the work vehicle 10 (e.g., the braking force controlled by the primary brake valve assembly 48) and the braking force associated with steering the vehicle 10 (e.g., the braking force controlled by the BAS brake valve assembly 110). To prevent such excessive braking forces from being applied to the wheels 18, 20, the first and second shuttle valves 58, 60 may be configured to prioritize the delivery of the flows of pressurized fluid from the primary and the BAS brake valve assembly 48, 110 to the first and second braking devices 42, 44. In one embodiment, the first shuttle valve 58 may be configured to permit the flow of pressurized fluid from the first primary brake valve 50 or the first BAS brake valve 112 having the higher fluid pressure, while occluding the flow of pressurized fluid from the first primary brake valve 50 or the first BAS brake valve 112 having the lower fluid pressure. Similarly, the second shuttle valve 60 may be configured to permit the flow of pressurized fluid from the second primary brake valve 52 or the second BAS brake valve 114 having the higher fluid pressure, while occluding the flow of pressurized fluid from the second primary brake valve 52 or the second BAS brake valve 114 having the lower fluid pressure. For example, when the braking force associated with slowing the ground speed of the work vehicle 10 is greater than the braking force associated with steering the vehicle 10, the first and second shuttle valves 58, 60 may be configured to permit delivery of pressurized fluid from the primary brake valve assembly 48 to the first and second braking devices 42, 44. In such instance, the first and second shuttle valves 58, 60 may also be configured to occlude the flow of pressurized fluid from the BAS brake valve assembly 110. However, it should be appreciated that, in alternative embodiments, a suitable controller may be configured to control the operation of the primary and BAS brake valve assemblies 48, 110 in a manner that performs a similar function.

Moreover, it should be appreciated that the braking system 46 may include any other suitable components that permit delivery of the fluid from the reservoir 54 to the first and second braking devices 42, 44. For example, in several embodiments, the braking system 46 may include a pump 62 configured to pressurize or otherwise pump the fluid from the reservoir 54 to the first and second braking devices 42, 44. Furthermore, in one embodiment, the braking system 46 may include a pressure relief valve 64 configured to open when the pressure within the braking system 46 exceeds a relief pressure threshold. Additionally, one or more suitable fluid conduits (e.g., hoses, pipes, tubes, and/or the like) may be configured to convey fluid between the various components of the braking system 46.

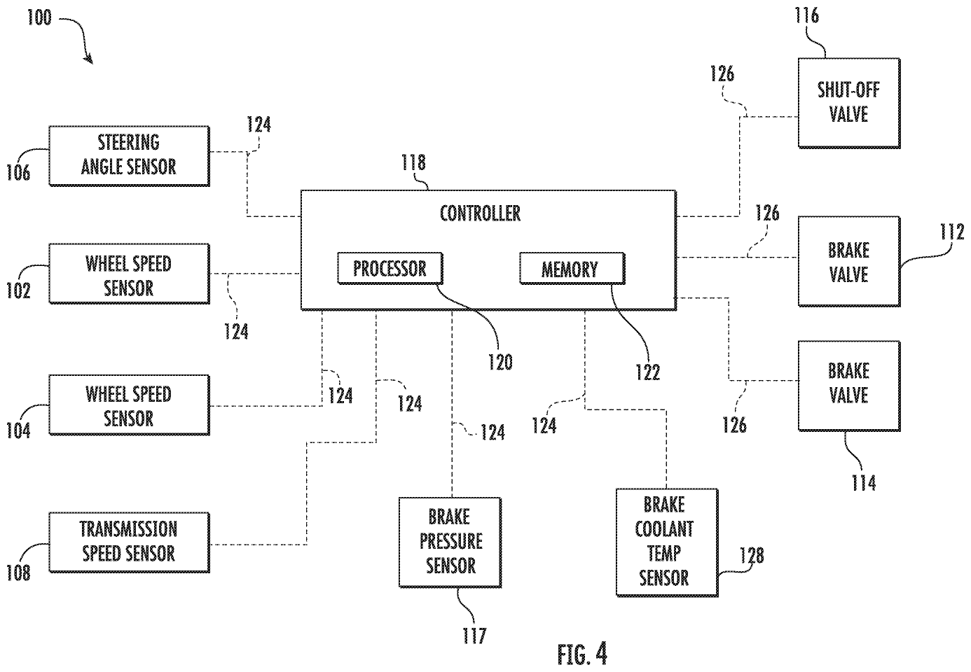

Furthermore, in one embodiment, a pressure sensor 117 may be provided in operative association with the braking system 46. In general, the pressure sensor 117 may be configured to detect or measure the pressure of the pressurized fluid supplied to the first and second braking devices 42, 44. For example, as shown in FIG. 4, the pressure sensor 117 may be provided in fluid communication with a fluid conduit extending between the shut-off of valve 116 and the first and second BAS brake valves 112, 114. As such, the pressure sensor 117 may be used to determine or verify the pressure of the fluid supplied to the BAS brake valve assembly 110. Alternatively, the pressure sensor 117 may be installed at any other suitable location that allows the pressure sensor 117 to measure the pressure of the fluid supplied within the BAS brake valve assembly 110, such as by installing the pressure sensor 117 in fluid communication with another fluid conduit of the braking system 46.

Additionally, it should be further appreciated that the configurations of the work vehicle 10 described above and shown in FIGS. 1-3 is provided only to place the present subject matter in an exemplary field of use. Thus, it should be appreciated that the present subject matter may be readily adaptable to any manner of vehicle configuration.

Referring now to FIG. 4, a schematic view of one embodiment of a system 100 for providing brake-assisted steering to a work vehicle in accordance with aspects of the present subject matter. In general, the system 100 will be described herein with reference to the work vehicle 10 described above with reference to FIGS. 1-3. However, it should be appreciated by those of ordinary skill in the art that the disclosed system 100 may generally be utilized with vehicles having any other suitable vehicle configuration.

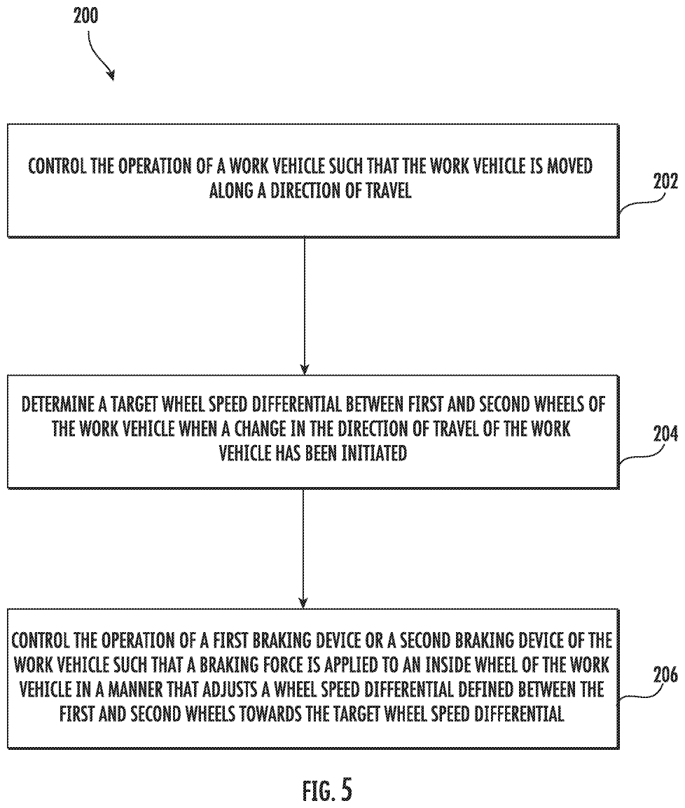

As shown, the system 100 may include a controller 118 configured to electronically control the operation of one or more components of the work vehicle 10. In general, the controller 118 may comprise any suitable processor-based device known in the art, such as a computing device or any suitable combination of computing devices. Thus, in several embodiments, the controller 118 may include one or more processor(s) 120 and associated memory device(s) 122 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 122 of the controller 118 may generally comprise memory element(s) including, but not limited to, a computer readable medium (e.g., random access memory (RAM)), a computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 122 may generally be configured to store suitable computer-readable instructions that, when implemented by the processor(s) 120, configure the controller 118 to perform various computer-implemented functions, such as one or more aspects of the method 200 described below with reference to FIG. 5. In addition, the controller 118 may also include various other suitable components, such as a communications circuit or module, one or more input/output channels, a data/control bus and/or the like.

It should be appreciated that the controller 118 may correspond to an existing controller of the work vehicle 10 or the controller 118 may correspond to a separate processing device. For instance, in one embodiment, the controller 118 may form all or part of a separate plug-in module that may be installed within the work vehicle 10 to allow for the disclosed system and method to be implemented without requiring additional software to be uploaded onto existing control devices of the work vehicle 10.

In several embodiments, the controller 118 may be configured to determine when the work vehicle 10 is being turned or its direction of travel 22 is otherwise being changed. Specifically, the controller 118 may be communicatively coupled to the steering angle sensor 106 via a wired or wireless connection to allow measurement signals (e.g., indicated by dashed line 124 in FIG. 4) to be transmitted from the steering angle sensor 106 to the controller 118. In this regard, the controller 118 may then be configured to monitor the steering angle of the work vehicle 10 as the vehicle 10 travels across the field based on the measurement signals 124 received from the steering angle sensor 106. For instance, the controller 118 may include a look-up table, suitable mathematical formula, and/or algorithms stored within its memory 122 that correlates the measurement signals 124 to the steering angle of the work vehicle 10. As such, when the monitored steering angle exceeds a threshold steering angle, the controller 118 may be configured to determine that the work vehicle 10 is being turned. It should be appreciated that the threshold steering angle may be selected to prevent the controller 118 from determining that the work vehicle 10 is being turned based on minor steering inputs (e.g., bumping of the steering wheel 32) that are not generally indicative of a turn.

Furthermore, when it is determined that the work vehicle 10 is being turned, the controller 118 may be configured to determine a target wheel speed differential between the inside and outside wheels of the work vehicle 10. As indicated above, upon receipt of a steering input, the steering actuator 34 may be configured to adjust the position of the steerable wheels 14, 16 relative to the frame 12 in a manner that defines a steering angle 40 therebetween. The steering angle 40 may generally be indicative of a desired turning radius of the vehicle 10. In order for the work vehicle 10 to complete a turn within the desired turning radius and without the inside wheel slipping, a particular wheel speed differential must exist between the inside and outside driven wheels 18, 20 of the vehicle 10. As such, in one embodiment, the controller 118 may be configured to determine a target wheel speed differential between the inside and outside wheels 18, 20 based on the monitored steering angle of the work vehicle 10. For instance, the controller 118 may include a look-up table, suitable mathematical formula, and/or algorithms stored within its memory 122 that correlates the monitored steering angle of the work vehicle 10 to the target wheel speed differential. Additionally, in one embodiment, the target wheel speed differential may also be based on an operating mode of the work vehicle 10. For example, when the work vehicle is being operated in a first operating mode (e.g., a normal or comfort mode), a first target wheel speed differential may be defined for a given turn. Moreover, when the vehicle is being operated in a second operating mode (e.g., an aggressive mode), a second target wheel speed differential may be defined for the given turn, with the second differential generally differing (e.g., being greater) than the first differential.

Thereafter, the controller 118 may be configured to control the operation of the first and second braking devices 42, 44 such that the braking force is applied to the inside wheel in a manner that adjusts the wheel speed differential towards the target wheel speed differential. Specifically, the controller 118 may be communicatively coupled to the first and second BAS brake valves 112, 114 via a wired or wireless connection to allow control signals (e.g., indicated by dashed line 126 in FIG. 4) to be transmitted from the controller 118 to the first and second BAS brake valves 112, 114. In this regard, the control signals 126 may be configured to instruct the first or second BAS brake valves 112, 114 to provide pressurized fluid to the first or second braking devices 42, 44 associated with the inside wheel of the work vehicle 10. Upon receipt of the pressurized fluid flow, the braking device 42, 44 associated with the inside wheel of the work vehicle 10 applies a braking force to the inside wheel in a manner that adjusts the wheel speed differential towards the target wheel speed differential.

In several embodiments, as the inside wheel of the work vehicle 10 is being braked, the controller 118 may be configured to monitor the wheel speed differential between the inside and outside driven wheels 18, 20. Specifically, the controller 118 may be communicatively coupled to the wheel speed sensors 102, 104 and/or the transmission speed sensor 108 via a wired or wireless connection to allow measurement signals 124 to be transmitted from the sensors 102, 104, 108 to the controller 118. In one embodiment, the controller 118 may then be configured to monitor the wheel speed differential based on the measurement signals 124 received from the wheel speed sensors 102, 104. For instance, the controller 118 may include a look-up table, suitable mathematical formula, and/or algorithms stored within its memory 122 that correlates the measurement signals 124 from the wheel speed sensors 102, 104 to the wheel speed differential. In another embodiment, the controller 118 may then be configured to monitor the wheel speed differential based on the measurement signals 124 received from one of the wheel speed sensors 102, 104 and the transmission speed sensor 108. For instance, the controller 118 may include a look-up table, suitable mathematical formula, and/or algorithms stored within its memory 122 that correlates the measurement signals 124 from one of the wheel speed sensors 102, 104 and a transmission speed sensor 108 to the wheel speed differential. In this regard, the controller 118 may be configured to compare the monitored wheel speed differential between the inside and outside wheels 18, 20 to the target wheel speed differential. As such, braking device 42, 44 may be configured to apply the braking force to the inside wheel as long as the monitored wheel speed differential is greater the target wheel speed differential. Once the monitored wheel speed differential reaches the target wheel speed differential, the braking of the inside wheel of the work vehicle 10 may be halted.

In one embodiment, when the work vehicle 10 is being turned, the controller 118 may be configured to control the first and second braking devices 42, 44 based on the wheel speed of the inside wheel. More specifically, when it is determined that the work vehicle 10 is being turned, the controller 118 may be configured to determine an expected wheel speed of the inside wheel based on measurement signals 124 received from the steering angle sensor 106 and the associated wheel speed sensor 102, 104. In general, the expected wheel speed of the inside wheel may be the wheel speed at which the work vehicle 10 is able to complete a turn within the turning radius indicated by the steering angle 40 of the vehicle 10 without the inside wheel slipping. For instance, the controller 118 may include a look-up table, suitable mathematical formula, and/or algorithms stored within its memory 122 that correlates the measurement signals 124 to the expected wheel speed of the inside wheel. Furthermore, the controller 118 may be configured to determine a target wheel speed of the inside wheel based on the expected wheel speed, with the target wheel speed being less than the expected wheel speed. For instance, the controller 118 may include a look-up table, suitable mathematical formula, and/or algorithms stored within its memory 122 that correlates the expected wheel speed of the inside wheel to its target wheel speed. Thereafter, the controller 118 may be configured to transmit control signals 126 to the first or second BAS brake valve 112, 114 associated with the inside wheel. Such control signals 126 may instruct the associated BAS brake valve 112, 114 to open such that the pressurized fluid is permitted to flow to the first or second braking device 42, 44 associated with the inside wheel. Upon receipt of the pressurized fluid, the associated braking device 42, 44 may apply a braking force to the inside wheel in a manner that reduces its wheel speed to the target wheel speed. It should be appreciated that, by reducing the wheel speed of the inside wheel below the expected wheel speed, the work vehicle 10 may be able to complete a turn in a smaller turning radius than indicated by the steering angle 40.

In accordance with aspects of the present subject matter, the controller 118 may be configured to monitor the temperature of the first and second braking devices 42, 44. More specifically, as the work vehicle 10 travels across a field, it may be necessary for the vehicle 10 to complete several turns, such as at the end of each row of the field. As described in above, the system 100 may be configured to activate first and second braking devices 42, 44 in a manner that provides brake-assisted steering to the work vehicle 10. The activation of the first and second braking devices 42, 44 may increase their temperatures as the braking devices 42, 44 generally dissipate energy through the generation of heat. As such, the controller 118 may be configured to monitor a parameter associated with the temperature of the first and/or second braking devices 42, 44 relative to a maximum parameter threshold. In the event that the monitored temperature of at least one of the first or second braking devices 42, 44 exceeds the maximum parameter threshold (thereby indicating that the first or second braking devices 42, 44 are too hot), the controller 118 may be configured to deactivate the brake-assisted steering of the work vehicle 10.

In one embodiment, the controller 118 may be configured to determine the temperature of the first and/or second braking devices 42, 44 based on a time duration across which the braking devices 42, 44 are activated. More specifically, the controller 118 may be configured to monitor the time duration across which the first and second braking devices the two, 44 are activated. Thereafter, in the event that the monitored time duration exceeds a predetermined maximum time duration, the controller 118 may be configured to deactivate the brake-assisted steering of the work vehicle 10. For example, the predetermined maximum time duration may be a total time period across which the first and/or second braking devices 42, 44 are continuously activated (e.g., one minute of continuous activation). The predetermined maximum time duration may also be a percentage of a time period during which he first and/or second braking devices 42, 44 are activated (e.g., three minutes of activation during a ten minute time interval). After brake-assisted steering has been deactivated, the controller 118 may be configured to reactivate brake-assisted steering after a deactivation time period has elapsed. The deactivation time period may be the same as or different than the predetermined time period threshold. Further, it should be appreciated that the time period may generally correspond to a time period that allows the first and/or second braking devices 42, 44 to sufficiently cool to prevent damage thereto.

In another embodiment, the controller 118 may be configured to estimate the temperature of the first and/or second braking devices 42, 44 based on measurement signals received from one or more sensors. More specifically, the controller 118 may be configured to estimate the temperature based on the amount of energy absorbed by the first and/or second braking devices 42, 44 and the amount of energy dissipated from the braking devices 42, 44 (e.g., by cooling the braking devices 42, 44). In one embodiment, the controller 118 may be configured to determine or estimate the amount of energy absorbed by the first and/or second braking devices 42, 44 based on the brake speed(s) of and the brake force(s) applied to the first and/or second braking devices 42, 44. For example, the controller 118 may be configured to determine the brake speed based on the measurement signals 124 received from the associated wheel speed sensor 102, 104. Moreover, the controller 118 may be configured to determine the brake force based on one or more aspects of the primary and/or BAS valves 50, 52, 112, 114. For example, the controller 118 may be configured to estimate the brake force by mapping the solenoid current applied to the primary and/or BAS valves 50, 52, 112, 114 to the regulated pressure of the fluid supplied to the first and second braking devices 42, 44. In another embodiment, the controller 118 may be configured to determine the brake force based pressure measurements from pressure sensors provided in operative association with fluid conduits directly coupled to the first and second braking devices 42, 44. Furthermore, the controller 118 may be configured to determine or estimate the amount of energy dissipated by the first and/or second braking devices 42, 44 based on the brake speed(s) and the brake coolant temperature(s) of the first and/or second braking devices 42, 44. Specifically, the controller 118 may be communicatively coupled to a brake coolant temperature sensor 128 provided in operative association with the brake coolant (e.g., oil) supplied to the first and/or second braking devices 42, 44 via a wired or wireless connection to allow measurement signals 124 to be transmitted from the brake coolant temperature sensor 128 to the controller 118. As such, the controller 118 may be configured to determine the temperature of the brake coolant that cools braking devices 42, 44 based on measurement signals 124 received from the brake coolant temperature sensor 128. In the event that the brake coolant temperature sensor 128 fails, the controller 118 may be configured to assume that the temperature of the brake coolant is at an upper limit of its operating range. Thereafter, the controller 118 may configured to estimate the temperature of the first and/or second braking devices 42, 44 by subtracting the amount of dissipated energy from the amount of absorbed energy, with the difference being indicative of the temperature. It should be appreciated that the controller 118 may include a look-up table, suitable mathematical formula, and/or algorithms stored within its memory 122 that correlates the measurement signals 124 received from the wheel speed sensors 102, 104, the brake pressure sensor 117, and the brake coolant temperature sensor 128 to the temperature(s) of the first and/or second braking devices 42, 44. Additionally, it should be appreciated that, in alternative embodiments, the controller 118 may be configured to estimate the temperature of the first and/or second braking devices 42, 44 based on any other suitable parameters and/or in any other suitable manner.

Moreover, in one embodiment, the controller 118 may be configured to determine or verify the pressure of the fluid supplied to the BAS brake valve assembly 110. Specifically, the controller 118 may be communicatively coupled to the brake pressure sensor 117 via a wired or wireless connection to allow measurement signals 124 to be transmitted from the brake pressure sensor 117 to the controller 118. In this regard, the controller 118 may then be configured to determine or verify the pressure of the fluid supplied to the BAS brake valve assembly 110 based on the measurement signals 124 received from the brake pressure sensor 117. For instance, the controller 118 may include a look-up table, suitable mathematical formula, and/or algorithms stored within its memory 122 that correlates the measurement signals 124 to the pressure of the fluid supplied to the BAS brake valve assembly 110.

As indicated above, when it is determined that the temperature of the first and/or second braking devices 42, 44 is too high, the controller 118 may be configured to deactivate the brake-assisted steering of the work vehicle 10. In several embodiments, the controller 118 may be configured to deactivate the brake-assisted steering by deactivating the BAS brake valve assembly 110. Specifically, in one embodiment, the controller 118 may be communicatively coupled to the shut-off valve 116 via a wired or wireless connection to allow control signals 126 to be transmitted from the controller 118 to shut-off valve 116. In this regard, the control signals 126 may be configured to instruct the shut-off valve 116 to occlude the flow of pressurized fluid to the first and second BAS brake valves 112, 114. As indicated above, when the flow of pressurized fluid to the brake valves 112, 114 is occluded, brake-assisted steering is deactivated. However, it should be appreciated that, in alternative embodiments, the controller 118 may be configured to control the operation of the first and/or second brake valves 112, 114 in a manner that prevents activating the brake assisted steering of the vehicle 10 when it is determined that the first and/or second braking devices 42, 44 are too hot.

Referring now to FIG. 5, a flow diagram of one embodiment of a method 200 for providing brake-assisted steering to a work vehicle is illustrated in accordance with aspects of the present subject matter. In general, the method 200 will be described herein with reference to the work vehicle 10 and the system 100 described above with reference to FIGS. 1-4. However, it should be appreciated by those of ordinary skill in the art that the disclosed method 200 may generally be utilized to provide brake-assisted steering to any work vehicle having any suitable vehicle configuration and/or in connection with any system having any suitable system configuration. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 5, at (202), the method 200 may include controlling, with a computing device, the operation of a work vehicle such that the work vehicle is moved along a direction of travel. For instance, as described above, a controller 118 may be configured to control the operation of one or more components of a work vehicle 10 such that the vehicle 10 is moved along a direction of travel 22.

Additionally, at (204), the method 200 may include determining, with the computing device, a target wheel speed differential between first and second wheels of the work vehicle when a change in the direction of travel of the work vehicle has been initiated. For instance, as described above, the controller 118 may be configured to determine a target wheel speed differential defined between the inside and outside wheels 18, 20 of the work vehicle 10 based on a monitored steering angle of the work vehicle 10 when it is determined that the vehicle 10 is being turned or its direction of travel 22 is otherwise being changed.

Moreover, as shown in FIG. 5, at (206), the method 200 may include controlling, with the computing device, the operation of a first braking device or a second braking device of the work vehicle such that a braking force is applied to an inside wheel of the work vehicle in a manner that adjusts a wheel speed differential defined between the first and second wheels towards the target wheel speed differential. For instance, as described above, the controller 118 may be configured to transmit control signals 126 to first or second BAS brake valves 112, 114 instructing the brake valves 112, 114 to provide a flow of pressurized fluid to a braking device 42, 44 associated with the inside wheel of the work vehicle 10. As such, the braking device 42, 44 applies a braking force to the inside wheel in a manner that reduces the wheel speed differential between the inside and outside wheels 18, 20 towards the target wheel speed differential.

It is to be understood that the steps of the method 200 are performed by the controller 118 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller 118 described herein, such as the method 200, is implemented in software code or instructions which are tangibly stored on a tangible computer readable medium. The controller 118 loads the software code or instructions via a direct interface with the computer readable medium or via a wired and/or wireless network. Upon loading and executing such software code or instructions by the controller 118, the controller 118 may perform any of the functionality of the controller 118 described herein, including any steps of the methods 200 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A system for providing brake-assisted steering to a work vehicle, the system comprising:
first and second wheels, one of the first or second wheels corresponding to an inside wheel of the work vehicle and another of the first or second wheels corresponding to an outside wheel of the work vehicle when a direction of travel of the work vehicle is being changed;
first and second braking devices, the first braking device configured to apply a braking force to the first wheel, the second braking device configured to apply a braking force to the second wheel;
at least one sensor configured to detect at least one parameter associated with a wheel speed differential defined between the first and second wheels; and
a controller communicatively coupled to the at least one sensor, the controller configured to determine a target wheel speed differential between the first and second wheels when it is determined that a change in the direction of travel of the work vehicle has been initiated, the controller further configured to control an operation of the first braking device or the second braking device such that a braking force is applied to the inside wheel in a manner that adjusts the wheel speed differential towards the target wheel speed differential.

2. The system of claim 1, further comprising:
a steering angle sensor configured to detect a parameter indicative of a steering angle of the work vehicle, the controller being configured to determine the target wheel speed differential based on measurement signals received from the steering angle sensor.

3. The system of claim 2, wherein the controller is further configured to:
determine a first target wheel speed differential between the first and second wheels based on the measurement signals received from the steering angle sensor when the work vehicle is operated in a first operational mode; and
determine a second target wheel speed differential between the first and second wheels based on the measurement signals received from the steering angle sensor when the work vehicle is operated in a second operational mode, the second target wheel speed differential differing from the first target wheel speed differential.

4. The system of claim 1, wherein the at least one sensor comprises a first wheel speed sensor provided in operative association with the first wheel and a second wheel speed sensor provided in operative association with the second wheel.

5. The system of claim 1, wherein the at least one sensor comprises a wheel speed sensor provided in operative association with one of the first wheel or the second wheel and a transmission speed sensor provided in operative association with a transmission of the work vehicle.

6. The system of claim 1, wherein the controller is further configured to:
monitor a parameter associated with a temperature of at least one of the first braking device or the second braking device relative to a maximum parameter threshold; and
deactivate brake-assisted steering when it is determined that the monitored parameter exceeds the maximum parameter threshold.

7. The system of claim 6, wherein the parameter associated with the temperature is a first time period across which the at least one of the first braking device or the second braking device has been actuated.

8. The system of claim 7, wherein, after deactivation, the controller is configured to reactivate the brake-assisted steering after a second time period has elapsed.

9. The system of claim 6, wherein the controller is further configured to estimate the temperature of the at least one of the first braking device or the second braking device based on at least one of a brake speed of, a brake force applied to, and brake coolant temperature associated with the corresponding braking device.

10. The system of claim 6, further comprising:
a first brake valve assembly configured to actuate the first and second brake devices when an input from an operator of the work vehicle is received; and
a second brake valve assembly configured to actuate the first and second brake device when an input from the controller is received,
wherein the controller is further configured to deactivate the second brake valve assembly when it is determined that the parameter associated with the temperature has exceeded the maximum parameter threshold.

11. The system of claim 1, wherein the first and second wheels are driven wheels.

12. A system for providing brake-assisted steering to a work vehicle, the system comprising:
first and second wheels, one of the first or second wheels corresponding to an inside wheel of the work vehicle when a direction of travel of the work vehicle is being changed;
first and second braking devices, the first braking device configured to apply a braking force to the first wheel, the second braking device configured to apply a braking force to the second wheel;
a steering angle sensor configured to detect a parameter indicative of a steering angle of the work vehicle;
a wheel speed sensor configured to detect a parameter associated with a wheel speed of the inside wheel;
a controller communicatively coupled to the steering angle sensor and the wheel speed sensor, the controller configured to:
determine an expected wheel speed of the inside wheel based on measurement signals received from the steering angle sensor and the wheel speed sensor when it is determined that a change in the direction of the work vehicle has been initiated;
determine a target wheel speed based on the expected wheel speed, the target wheel speed being less than the expected wheel speed; and
control an operation of the first or second braking device in a manner that reduces a wheel speed of the inside wheel to the target wheel speed.

13. A method for providing brake-assisted steering to a work vehicle, the method comprising:
controlling, with a computing device, an operation of a work vehicle such that the work vehicle is moved along a direction of travel, the work vehicle including first and second wheels, one of the first or second wheels corresponding to an inside wheel of the work vehicle when the direction of travel of the work vehicle is being changed, the work vehicle further including a first braking device configured to apply a braking force to the first wheel, and a second braking device configured to apply a braking force to the second wheel;
determining, with the computing device, a target wheel speed differential between the first and second wheels when a change in the direction of travel of the work vehicle has been initiated;
controlling, with the computing device, an operation of the first braking device or the second braking device such that a braking force is applied to the inside wheel in a manner that adjusts a wheel speed differential defined between the first and second wheels towards the target wheel speed differential.

14. The method of claim 13, wherein the target wheel speed differential is determined based on a parameter indicative of a steering angle of the work vehicle.

15. The method of claim 14, further comprising:
determining, with the computing device, a first target wheel speed differential between the first and second wheels based the steering angle when the work vehicle is operated in a first operational mode; and
determining, with the computing device, a second target wheel speed differential between the first and second wheels based the steering angle when the work vehicle is operated in a second operational mode, the second target wheel speed differential differing from the first target wheel speed differential.

16. The method of claim 13, further comprising:
monitoring, with the computing device, a parameter associated with a temperature of at least one of the first braking device or the second braking device relative to a maximum parameter threshold; and
deactivating, with the computing device, brake-assisted steering when it is determined that the monitored parameter exceeds the maximum parameter threshold.

17. The method of claim 16, wherein the parameter associated with the temperature is a first time period across which the at least one of the first braking device or the second braking device has been actuated.

18. The method of claim 17, further comprising:
after deactivation, reactivating, with the computing device, the brake-assisted steering after a second time period has elapsed.

19. The method of claim 16, further comprising:
estimating, with the computing device, the temperature of the at least one of the first braking device or the second braking device based on a brake speed of, a brake force applied to, and brake coolant temperature associated with the corresponding braking device.
